(19) United States
(12) Patent Application Publication
(10) Pub. No.: US 2005/0091924 A1
(43) Pub. Date: May 5, 2005

(54) Shutters for door and window frames and methods of producing shutters for door and window frames

(76) Inventor: Emilio Antonini, Trieste (IT)

Correspondence Address: KNOBBE MARTENS OLSON & BEAR LLP, 2040 MAIN STREET, FOURTEENTH FLOOR, IRVINE, CA, 92614, US

(21) Appl. No.: 10/978,167

(22) Filed: Oct. 29, 2004

(30) Foreign Application Priority Data
Oct. 31, 2003 (IT) UD 2003 A 000216

(51) Int. Cl. E06B 7/08

(52) U.S. Cl. 49/74.1

(57) ABSTRACT

A shutter including a unique configuration for pivotably mounting a plurality of louvers is provided herein. The louvers are mounted at either end to first and second connection and orientation elements. The first and second connection and orientation elements are received within groove in first and second stiles. Upper and lower rails may be secured at upper and lower ends, respectively, of the stiles. Methods of producing such a shutter are also provided herein. The methods include the step of producing a cartridge-like screening panel module in a standard length. The module is easily cut to produce a module segment of a desired length. The methods thus allow manufacturers of custom shutters to use standard size parts to produce custom-made shutters. The methods reduce the cost and production time of custom-made shutters.

### RELATED APPLICATION

This application claims priority to Italian application Serial No. UD 2003 A 000216, filed on Oct. 31, 2003, the entire contents of which are hereby expressly incorporated by reference.

### BACKGROUND OF THE INVENTION

1. Field of the Invention

The present invention relates to shutters for doors and window frames, and to methods of producing and assembling such shutters.

2. Description of the Related Art

Shutters for door and window frames are known in the prior art. Such shutters include Venetian blinds, and generally comprise a peripheral frame surrounding a plurality of louvers. The louvers pivot about their ends. An adjustment rod connects the louvers to each other. The adjustment rod enables a user to orient the louvers at a plurality of angles. For example, in a closed position the louvers allow a minimum level of light pass through the shutter. In an open position, the louvers allow a maximum amount of light to pass.

Many shutters are custom produced. The shutters are thus able to match the dimensions of the frame with which they are associated. The louvers in custom shutters are produced with a length correlated to the internal width of the peripheral frame. The louvers are then assembled, one by one, in a number correlated to the internal height of the same peripheral frame. Because of the wide variations in size between different door and window frames, it is difficult to use standard size components to produce custom shutters. Manufacturers of custom shutters generally have to start from scratch, custom producing each component of a given shutter once they receive the customer's specifications for that shutter.

Between different shutters, the pitch of the louvers may vary. Pitch generally refers to the distance between neighboring louvers, and is related to the depth of the louvers. Depth is generally measured along an axis that is perpendicular to a plane defined by the peripheral frame. These varying pitches further complicate the construction of custom shutters, because many of the operations required to construct the various components of a given shutter cannot be performed until the depth of the shutter has been determined.

Furthermore, these construction operations require end precision, qualified personnel and special equipment. For example, in the current state of the art, after each louver has been cut to size, it must be painted, and the two ends of the louver must be drilled and outfitted with rotation pins. One or more intermediate portions of each louver must then be drilled to attach the anchorage system for the rotation rod, which must also be drilled and then anchored to the louvers.

As the above examples illustrate, the production process for some current shutters is expensive and time consuming. Each component of each shutter must be custom prepared according to the requests of the client. These processes generally cannot begin until the customer provides the specifications for the finished shutter. Custom shutter manufacturers are therefore very limited in their ability to use standard size components, which ultimately increases the cost and production time of custom made shutters. Therefore, a shutter that enabled the use of standard size components would lower the cost and production time of custom-made shutters.

### SUMMARY OF THE INVENTION

The preferred embodiments of the present shutters for door and window frames and methods of producing shutters for door and window frames have several features, no single one of which is solely responsible for their desirable attributes. Without limiting the scope of these shutters and methods of producing shutters as expressed by the claims that follow, their more prominent features will now be discussed briefly. After considering this discussion, and particularly after reading the section entitled “Detailed Description of the Preferred Embodiments,” one will understand how the features of the preferred embodiments provide advantages, which include enabling manufacturers of custom shutters to use standard size components in the manufacture and assembly of custom shutters.

One embodiment of the present shutters for door and window frames and methods of producing shutters for door and window frames comprises a method for producing a shutter for a door frame or a window frame. The method comprises the step of assembling a screening panel module. The module includes at least one louver pivotably connected at either end to first and second connection and orientation elements. The method further comprises the step of cutting the first and second connection and orientation elements to produce a screening panel module segment of a desired length. The method further comprises the step of assembling a peripheral frame adapted to contain and support the screening panel module segment. The method further comprises the step of combining the screening panel module segment with the peripheral frame to produce the finished shutter.

Another embodiment of the present shutters for door and window frames and methods of producing shutters for door and window frames comprises a method for producing a shutter for a door frame or a window frame. The method comprises the step of assembling a plurality of screening panel modules of a standard length. Each module includes at least one louver pivotably connected at either end to first and second connection and orientation elements. The method further comprises the step of selecting one of the plurality of screening panel modules and cutting the first and second connection and orientation elements thereof to produce a screening panel module segment of a desired length. The method further comprises the step of assembling a peripheral frame adapted to contain and support the screening panel module segment. The method further comprises the step of combining the screening panel module segment with the peripheral frame to produce the finished shutter.

Another embodiment of the present shutters for door and window frames and methods of producing shutters for door and window frames comprises a shutter for a door frame or a window frame, including first and second connection and orientation elements spaced from one another and arranged substantially parallel to one another. The shutter further comprises at least one louver pivotably connected at either end to the first and second connection and orientation elements. The shutter further comprises first and second stiles. Each stile includes a longitudinal groove in an inside face thereof. Each groove receives and seats one of the first and second connection and orientation elements.

### BRIEF DESCRIPTION OF THE DRAWINGS

The preferred embodiments of the present shutters for door and window frames and methods of producing shutters for door and window frames, illustrating its features, will now be discussed in detail. These embodiments depict the novel and non-obvious shutters and methods of producing shutters shown in the accompanying drawings, which are for illustrative purposes only. These drawings include the following figures, in which like numerals indicate like parts:

FIG. 1 is an exploded front perspective view of one embodiment of the present shutter for door and window frames, illustrating various components of the shutter in an un-assembled configuration;

FIG. 2 is an exploded front perspective view of the shutter of FIG. 1, illustrating various components of the shutter in a partially assembled configuration;

FIG. 3 is a front perspective view of the shutter of FIG. 1, illustrating the shutter in an assembled configuration; and

FIG. 4 is a front cross-sectional view of a portion of the shutter of FIG. 1, illustrating the pivotable connection between each louver and the connection and orientation element.

### DETAILED DESCRIPTION OF THE PREFERRED EMBODIMENTS

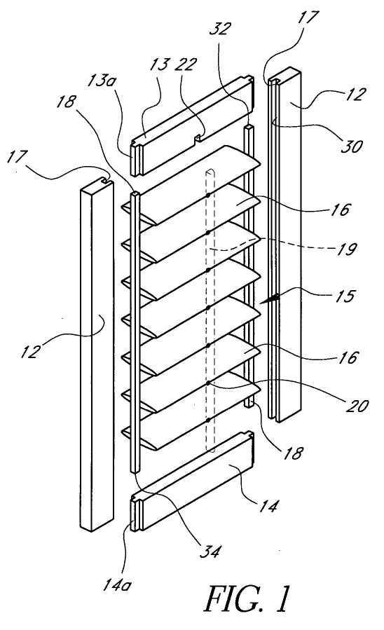

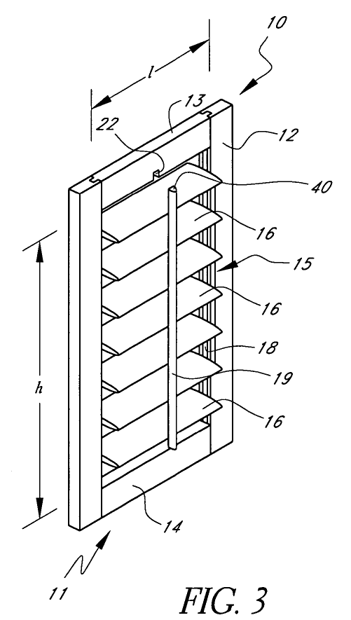

FIGS. 1-3 illustrate one embodiment of the present shutter 10 (FIG. 3) for door and window frames. The shutter 10 comprises a peripheral frame 11 (FIG. 3). With reference to FIG. 1, the frame 11 includes two uprights or stiles 12, a first or upper crosspiece or rail 13 and a second or lower crosspiece or rail 14. With reference to FIG. 3, the stiles 12 are substantially vertical and spaced from one another a distance 1. The rails 13, 14 are substantially horizontal and spaced from one another a distance h.

A screening panel 15 is clamped inside the frame 11. With continued reference to FIG. 3, the screening panel 15 comprises a plurality of slats or louvers 16. Each of the louvers 16 may have a tapered surface. The louvers 16 are arranged parallel to one another and extend horizontally between the stiles 12. Generally, the louvers 16 cover the entire internal height h of the peripheral frame 11. Each louver 16 is generally of an appropriate length to extend across the entire internal width l of the frame 11.

With reference to FIG. 1, each louver 16 is pivotably mounted at either end to two vertically extending connection and orientation elements 18. Each louver 16 is thus rotatable about its longitudinal axis. The orientation of each louver 16 about its longitudinal axis affects the amount of light that is able to pass through the shutter 10. When a plane defined by each louver 16 is substantially parallel to the ground, as in FIG. 3, a large amount of light is able to pass through the shutter 10. Conversely, when a plane defined by each louver 16 is substantially perpendicular to the ground, a small amount of light is able to pass through the shutter 10.

In the illustrated embodiment, the connection and orientation elements 18 are shaped as elongate bars or shafts having a substantially square cross-section. Those of skill in the art will appreciate that the elements 18 could have any cross-sectional shape, and could be of any length. For simplicity, the elements 18 will be referred to below as connection shafts 18.

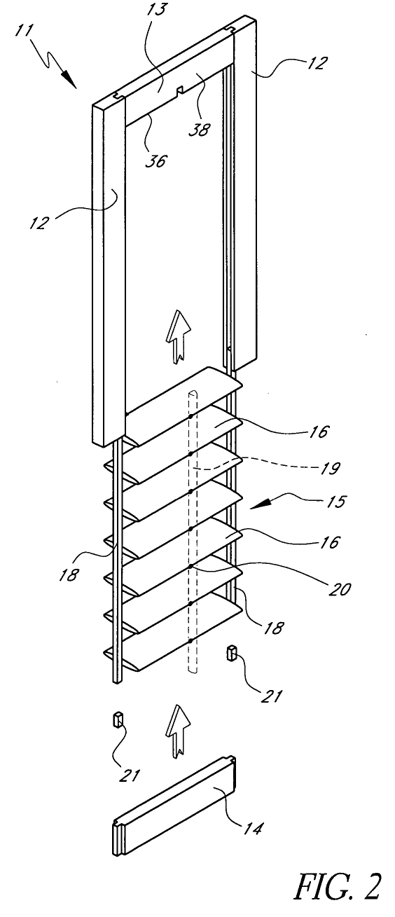

With reference to FIGS. 1 and 2, each connection shaft 18 is sized to slidably fit within a longitudinal groove 17 in an internal face 30 of each stile 12. A length of each connection shaft 18 is substantially equal to the internal height h of the peripheral frame 11 (FIG. 3). The junction of each connection shaft 18 and its respective groove 17 may be secured by any appropriate means, such as nails or adhesive, for example.

Opposite ends of the upper and lower rails 13, 14 include tenons 13a, 14a, respectively (FIG. 1). Each tenon 13a, 14a is sized to fit snugly within the grooves 17 on the stiles 12. The junction of each tenon 13a, 14a and its respective groove 17 may be secured by any appropriate means, such as nails or adhesive, for example. The tenons 13a on the upper rail 13 preferably abut an upper end 32 of each connection shaft 18. Similarly, the tenons 14a on the lower rail 14 preferably abut a lower end 34 of each connection shaft 18. If there are gaps between the upper rail 13 and the upper end 32, or between the lower rail 14 and the lower end 34, filling elements 21 (FIG. 2) may be inserted into the grooves 17 to fill the gaps. The filling elements 21 comprise segments of the connection shafts 18.

With reference to FIGS. 1-3, at least one adjustment rod 19 is preferably secured to a front surface of each louver 16. At least one additional adjustment rod (not shown) may be secured to a rear surface of each louver 16. Those of skill in the art will appreciate that the adjustment rods need not be secured necessarily directly to the front and/or rear surfaces of the louvers 16. Attachment hardware (not shown) could secure the adjustment rods to upper and/or lower surfaces of the louvers 16. However, the adjustment rods are preferably disposed in front of and/or behind the louvers 16.

By moving the adjustment rod 19 upward or downward, a user can pivot the louvers 16 to alter the amount of light coming through the shutters 10. In the illustrated embodiment, one adjustment rod 19 is shown, and the adjustment rod 19 is located near a longitudinal center of each louver 16. However, those of skill in the art will appreciate that the adjustment rod 19 could be located anywhere along the louvers 16. For example, if two adjustment rods 19 are provided, the adjustment rods 19 could be evenly spaced from one another.

The connection between the at least one adjustment rod 19 and each louver 16 may embody any appropriate connection, such as the many types of articulated connections known to those of skill in the art. One example of such a connection is illustrated in PCT publication Serial No. WO 02/31307, which is expressly incorporated herein by reference. To facilitate attachment of the adjustment rod 19 to the louvers 16, the louvers 16 may include holes 20 (FIG. 1) that are adapted to receive fastening members (not shown).

A lower edge 36 (FIG. 2) of a front surface 38 (FIG. 2) of the upper rail 13 may include a small depression 22 (FIG. 3). The depression 22 is preferably aligned with the adjustment rod 19. Thus, in the illustrated embodiment the depression 22 is located near a longitudinal center of the upper rail 13. The depression 22 is thus adapted to receive an upper tip 40 of the rod 19 when the rod 19 occupies its upper end of travel position. As those of skill in the art will appreciate, if the shutter 10 includes more than one rod 19, then the upper rail 13 may include a corresponding number of depressions 22, with each depression 22 being aligned with a corresponding rod 19. Those of skill in the art will also appreciate that the lower rail 14 may include a depression (not shown) corresponding to each rod 19.

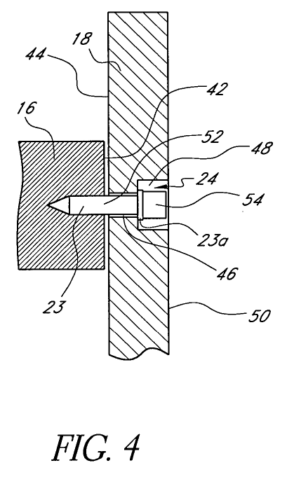

FIG. 4 illustrates one embodiment of the pivotable connection between each louver 16 and the connection shafts 18. An end face 42 of each louver 16 abuts an inside face 44 of the connection shaft 18. The connection shaft 18 includes a countersunk bore 24, with a smaller diameter hole 46 extending through the inside face 30, and a larger diameter hole 48 extending through an outside face 50 of the connection shaft 18. An attachment member, such as a pin 23, extends through the smaller diameter hole 46.

The attachment member 23 includes a shaft portion 52 having a first diameter, and a head portion 54 having a second, larger diameter. The shaft portion 52 preferably has approximately the same diameter, though slightly smaller, as the smaller diameter hole 46. The head portion 54 has a larger diameter than the smaller diameter hole 46. Thus, the shaft portion 52 is able to extend through the smaller diameter hole 46, while the head portion 54 resides within the larger diameter hole 48. Because the head portion 54 resides within the countersunk larger diameter hole 48, the attachment member 23 does not interfere with the interengagement of the connection shaft 18 and the stile 12. The overall frame 11 is thus capable of being very compact. In the illustrated embodiment, the attachment member 23 includes a washer 23a that is disposed between the head portion 54 and the smaller diameter hole 46. However, those of skill in the art will appreciate that the washer 23a need not be provided.

To assemble a finished shutter 10, each screening panel 15, or a plurality of segments thereof, is combined with the frame 11. The assembly steps may be performed in any of a variety of orders. For example, as the first step the connection shafts 18 are inserted into the grooves 17 on the stiles 12. The junction of the connection shafts 18 and the grooves 17 may be secured with any appropriate fastening means, such as nails or adhesive. If filling elements 21 are desired, they may be added at this time. When the insertion is complete, the upper and lower rails 13, 14 are combined with the frame 11 by inserting the tenons 13a, 14a into the grooves 17 on the stiles 12. The junction of the tenons 13a, 14a and the grooves 17 may be secured with any appropriate fastening means, such as nails or adhesive. Finally, at least one adjustment rod 19, having a length substantially corresponding to the height of the whole screening panel 15, is fixed to the louvers 16. Those of skill in the art will appreciate that the step of securing the at least one adjustment rod 19 to the louvers 16 could be performed at any point during the assembly process.

In an alternative order, illustrated in FIG. 2, as a first step the upper rail 13 is combined with the stiles 12 by inserting the tenons 13a into the grooves 17. The junction of the tenons 13a and the grooves 17 may be secured with any appropriate fastening means, such as nails or adhesive. The screening panel module 15 is then combined with the frame 11 by sliding the connection shafts 18 into the grooves 17 on the stiles 12. The entire module thus slides into the frame 11 like a cartridge. The junction of the connection shafts 18 and the grooves 17 may be secured with any appropriate fastening means, such as nails or adhesive. If filling elements 21 are desired, they may be added at this time. When the insertion is complete, the lower rail 14 is combined with the frame 11 by inserting the tenons 14a into the grooves 17 on the stiles 12. The junction of the tenons 14a and the grooves 17 may be secured with any appropriate fastening means, such as nails or adhesive. Finally, at least one adjustment rod 19, having a length substantially corresponding to the height of the whole screening panel 15, is fixed to the louvers 16. Those of skill in the art will appreciate that the step of securing the at least one adjustment rod 19 to the louvers 16 could be performed at any point during the assembly process.

In one embodiment of the present shutter 10, the screening panel 15 may advantageously be produced in the form of a pre-assembled, standard-length strip or module. Each module comprises a plurality of louvers 16 pivotably secured at either end to standard-length connection shafts 18. After the modules are constructed, they are supplied to an assembly facility.

At the assembly facility, each module is cut to an appropriate length to match the height of a given shutter 10 that is to be made. After each module is cut, any remaining portion of that module is advantageously available for use in another shutter 10. A plurality of leftover segments from cut modules can be used to complete a shutter 10, according to the desired height of that shutter 10. Thus, any leftover segments, no matter how small, can be used to produce another shutter 10. In this manner, no parts of a module go unused, no matter what length the module had when it was first produced.

As the above discussion illustrates, various embodiments of the present shutters reduce production costs and production time. For example, a specialized manufacturing facility is able to manufacture the modules described above using specialized equipment, such as elaborate saws and drills. Such a manufacturing facility could be located in an area with an abundant supply of inexpensive labor, which would lower the overall cost of producing the shutters 10. Because of the specialized nature of the manufacturing facility, it is adaptable to mass production methods and automation, which further reduce the overall cost and time required to produce the shutters 10. Those of skill in the art will appreciate that the manufacturing and assembly facilities could be combined at a single location.

The manufacturing facility would produce modules of a standard length, and perhaps in a variety of widths. For example, in one embodiment widths range from 4 inches to 48 inches, in ½ inch increments. In another embodiment widths range from about 11.3 inches to 25.4 inches, in increments of 2.35 inches. Those of skill in the art will appreciate that these widths and increments are merely examples, and are not intended to be limiting. The modules could be painted and finished at the manufacturing facility. The manufacturing facility would produce modules of varying pitches (wherein the depth of each module varies from module to module).

The manufacturing facility could also produce the remaining components of each shutter 10, such as the stiles 12 and the rails 13, 14 for supply to the assembly facility. Custom shutter manufacturers are then able to maintain a stock of standard-length and standard-depth components to be used to assemble finished shutters. This ability of the manufacturers to construct finished shutters from components having standard lengths and standard depths reduces the overall cost of the shutters to the consumer, because the manufacturers do not have to custom produce each component.

Upon completion, the modules are shipped to an assembly facility. There, modules having desired depths are selected, and the modules are cut to desired lengths to fill custom orders for shutters 10. The properly sized modules are combined with vertical stiles 12 and horizontal rails 13, 14 as described above. No portion of a module is wasted, because scraps from cut modules are combinable with other scraps to produce a multi-segmented module of any desired length. The assembly process is quick and easy, because the modules are simply slid, as a one-piece cartridge or multi-segmented cartridge, into the grooves 17 in the stiles 12. Then, the upper and lower rails 13, 14 are added and the adjustment rod 19 is added. Finally, the entire shutter 10 may be secured by any appropriate means, such as nails or adhesive.

The assembly facility does minimal painting and/or finishing, because the assembly facility is able to maintain a supply of pre-painted and pre-finished stiles 12 and rails 13, 14 in a variety of lengths. These components are quickly assembled with the cut modules. Some stiles 12 may need to be cut to match the length of the finished shutters 10, but any painting and/or finishing of these components would only be to the ends thereof once the cuts are made. The assembly facility would also cut the adjustment rods 19 to desired lengths and secure them to the louvers 16, as described above. Again, any painting and/or finishing of these components would only be to the ends thereof once the cuts are made.

As the above discussion illustrates, various embodiments of the present shutters 10 allow for considerable reductions in the production time and costs of making shutters, as compared to the current state-of-the-art. The assembly facility is relieved of the burden of performing a wide variety of production operations, including all of the drilling, and much of the cutting, finishing, and assembling. For example, the assembly facility does not perform the step of pivotably securing the louvers 16 to the frame 11. The manufacturing facility may perform any preliminary steps to facilitate the attachment of the adjustment rod 19 to the louvers 16, such as drilling the holes 20, and/or attaching any articulating components.

Those of skill in the art will appreciate that many variations from the illustrated embodiments are well within the scope of the present shutters 10. For example, the peripheral frame 11 may comprise only one of the two rails 13, 14. Alternatively, the peripheral frame 11 may not comprise either of the two rails 13, 14, and may only include the two stiles 12.

### Scope of the Invention

The above presents a description of the best mode contemplated for carrying out the present shutters for door and window frames and methods of producing shutters for door and window frames, and of the manner and process of making and performing the same, in such full, clear, concise, and exact terms as to enable any person skilled in the art to which they pertains to make these shutters and to perform these methods. These shutters and methods of producing shutters are, however, susceptible to modifications and alternate constructions from that discussed above that are fully equivalent. Consequently, these shutters and methods of producing shutters are not limited to the particular embodiments disclosed. On the contrary, these shutters and methods of producing shutters cover all modifications and alternate constructions coming within the spirit and scope of these shutters and methods of producing shutters as generally expressed by the following claims, which particularly point out and distinctly claim the subject matter of these shutters and methods of producing shutters.

1. A method for producing a shutter for a door frame or a window frame, the method comprising the steps of:
assembling a screening panel module, the module including at least one louver pivotably connected at either end to first and second connection and orientation elements;
cutting the first and second connection and orientation elements to produce a screening panel module segment of a desired length;
assembling a peripheral frame adapted to contain and support the screening panel module segment; and
combining the screening panel module segment with the peripheral frame to produce the finished shutter.

2. The method of claim 1, wherein the first and second connection and orientation elements each comprise elongate members that are adapted to seat within the peripheral frame.

3. The method of claim 2, wherein the peripheral frame comprises first and second stiles, each stile including a longitudinal groove in an inside face thereof that is adapted to receive one of the first and second connection and orientation elements.

4. The method of claim 3, wherein the step of combining the screening panel module segment with the peripheral frame further comprises the step of inserting the first and second connection and orientation elements into the grooves in the stiles.

5. The method of claim 1, wherein the step of assembling the peripheral frame further comprises the step of combining at least one of an upper rail and a lower rail with first and second stiles.

6. The method of claim 1, wherein the step of combining the screening panel module segment with the peripheral frame further comprises the step of combining at least one of an upper rail and a lower rail with first and second stiles.

7. The method of claim 1, further comprising the step of securing an adjustment rod to a front surface of the at least one louver, the adjustment rod facilitating adjustment of an orientation of the at least one louver relative to the first and second connection and orientation elements.

8. A method for producing a shutter for a door frame or a window frame, the method comprising the steps of:
assembling a plurality of screening panel modules of a standard length, each module including at least one louver pivotably connected at either end to first and second connection and orientation elements;
selecting one of the plurality of screening panel modules and cutting the first and second connection and orientation elements thereof to produce a screening panel module segment of a desired length;
assembling a peripheral frame adapted to contain and support the screening panel module segment; and
combining the screening panel module segment with the peripheral frame to produce the finished shutter.

9. The method of claim 8, wherein the step of assembling a plurality of screening panel modules is carried out at a manufacturing facility.

10. The method of claim 9, wherein the steps of selecting one of the plurality of screening panel modules, cutting the first and second connection and orientation elements, assembling a peripheral frame adapted, and combining the screening panel module segment with the peripheral frame are carried out at an assembly facility.

11. The method of claim 10, wherein the manufacturing facility and the assembly facility are in separate locations.

12. The method of claim 10, wherein the manufacturing facility and the assembly facility are at the same location.

13. A shutter for a door frame or a window frame, comprising:
first and second connection and orientation elements spaced from one another and arranged substantially parallel to one another;
at least one louver pivotably connected at either end to the first and second connection and orientation elements; and
first and second stiles, each stile including a longitudinal groove in an inside face thereof, each groove receiving and seating one of the first and second connection and orientation elements.

14. The shutter of claim 13, wherein the at least one louver and the first and second connection and orientation elements comprise a pre-assembled module.

15. The shutter of claim 14, further comprising at least one of an upper rail and a lower rail, the at least one rail extending between the stiles.

16. The shutter of claim 15, wherein the at least one of an upper rail and a lower rail aids in retaining the pre-assembled module within the first and second stiles.

17. The shutter of claim 15, wherein the at least one rail includes tenons at either end thereof, and the tenons are adapted to seat within the grooves in the first and second stiles.

18. The shutter of claim 13, further comprising at least one adjustment rod connected to a front surface of the at least one louver.

19. The shutter of claim 13, wherein elongate fastening members pivotably mount the ends of the louver to their respective connection and orientation element.

20. The shutter of claim 19, wherein each fastening member includes a shaft portion having a first diameter and a head portion having a second, larger diameter, and fastening member seats within a countersunk bore in the connection and orientation element such that the shaft portion extends through a first portion of the bore having a first diameter and the head portion resides within a second portion of the bore having a second, larger diameter.
